(19) United States
(12) Patent Application Publication
(10) Pub. No.: US 2007/0266690 A1
(43) Pub. Date: Nov. 22, 2007

(54) FLOW ENHANCEMENT FOR ROOT CROP HARVESTERS

(76) Inventors: Brad S. Buehler, Berthoud, CO (US); Howard W. Taylor, Armstrong, IA (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/419,519

(22) Filed: May 22, 2006

(51) Int. Cl. A01D 23/02

(52) U.S. Cl. 56/121.4

(57) ABSTRACT

A harvester for root crops such as beets is provided which preferably provides improved flow of root crops from a lifting assembly, along a plurality of transfer assemblies, and to a holding tank or a separate loading vehicle. Each transfer assembly includes a transfer surface, typically a conveyor or roller, for the downstream movement of harvested root crops. At least one of the transfer assemblies includes a movable stagnation reduction member mounted for rotation above the associated transfer surface. The movable member is typically positioned at a transition region of the flowpath in order to provide a “moving wall” that contacts harvested root crops to urge them downstream and prevent stagnation at the transition region. The movable member may be driven by any of a number of possible mechanisms or undriven and rotated by contact with the flow of crops.

### BACKGROUND OF THE INVENTION

1. Field of the Invention

This invention generally relates to harvesters for the harvesting of crops that must be removed from the ground, more particularly, root crops such as beets.

2. Description of Related Art

Efficient flow through a root crop or beet harvester is critical to a high yield of clean, undamaged root crops. One obstacle to efficient flow is stagnation, wherein a large number of harvested crops congregate and pile up in a particular area, rather than moving smoothly through the harvester. This pile of crops causes operational problems, such as plugging, mud build-up, and crop damage at the stagnation site, but also causes problems elsewhere in the harvester. For example, some operators may attempt to dissipate the stagnation point by increasing the speed of the associated rollers and/or conveyors. This increased speed is harmful to the harvested crops passing around the stagnation point, because they may move too quickly to be properly cleaned and they may also become damaged at higher machinery cycle speeds. These problems are magnified by wet field conditions and soggy or slippery crops, which increase the occurrence of stagnation.

Stagnation can occur at almost any point in the flowpath of a harvester, but the problem is especially prevalent in and around transition areas. When used herein, the terms “transition areas” or “transition regions” refer generally to locations where harvested root crops are forced to either change direction within the harvester and/or to move to another harvester assembly. Directional changes include transitions between substantially lateral, substantially rearward, substantially forward, and/or substantially vertical movement of the root crops within the harvester. Requiring the flow of crops to separate and move around a wall or other structure situated in the flowpath is another example of a change of direction. Several typical transition areas which are subject to stagnation in known root crop harvesters are shown in broken lines in FIGS. 1-3.

For example, stagnation often occurs along rollers intended to move the crops perpendicularly to the axes of the rollers. One common example of such an arrangement is in a header assembly 10, which is illustrated in FIG. 1. The general flow of crops through the harvester 12 of FIG. 1 is from right to left, from a lifting assembly 14, to the header assembly 10, then to a short conveyor assembly 16, and finally to a grabroller assembly 18 and an elevator assembly 20, where they are deposited in a storage tank, which is not illustrated.

As shown in FIG. 1, the header rollers 22 of the header assembly 10 are orientated perpendicularly to the general direction of crop flow, so the header rollers 22 are provided with wear bands 24 to force the crops downstream. The short conveyor assembly 16 is narrower than the header assembly 10 so, in addition to moving the crops downstream, the header rollers 22 must also move the crops generally to a central region A so that they will drop onto the short conveyor assembly 16. This change of direction is characteristic of many problematic transition areas. In the harvester 12 of FIG. 1, the illustrated funneling of crops by the header rollers 22 can lead to stagnation at the central region A of the header assembly 10, as the crops tend to be moved to the central region A faster than they can be moved downstream. When used herein to refer to the orientation of the various harvester assemblies and to the flow of root crops, the term “downstream” is not limited to a location closer to the rear of the harvester, but instead refers to a location or assembly further along the flowpath of the root crops. For example, a conveyor that processes the root crops after they are raised by the elevator assembly is “downstream,” regardless of its placement within the harvester.

Stagnation is also common at transition areas in which the harvested root crops move from one harvester transfer assembly to another, such as from a grabroller assembly to an elevator assembly at a region generally designated at B in FIGS. 1-3. Stagnation is even more prevalent when the downstream assembly is narrower than the upstream assembly, as shown at regions C of FIG. 1, or when the adjacent assemblies cause the crops to travel at different speeds or to change direction.

Locations that require the crops to “turn the corner,” i.e., to make a sudden 90° turn, are especially problematic. For example, FIG. 2 illustrates a typical root crop harvester 110, in which crops are moved to the rear of the harvester by a lifting assembly 112, a header assembly 114, and a conveyor assembly 116, before they are moved laterally by a grabroller assembly 118 to an elevator assembly 120. The crops do not instantly respond to the sudden change of direction between the rearward flow over the conveyor 122 of the conveyor assembly 116 and the lateral flow over the grabroller assembly 118, which often leads to stagnation at the feed area D of the grabroller assembly 118. This stagnation affects even the crops that avoid being piled up, because the build-up of mud and debris left by crops passing through these locations makes it more difficult for the grabrollers 124 of the grabroller assembly 118 to rotate and clean the following flows of crops at such areas as well as at other areas of the grabroller assembly 118.

Portions of a flowpath that require the crops to move around a stationary structure are also subject to stagnation. The region E near the elevator assembly 120 of FIG. 2 is one such example. As illustrated, many crops must be moved laterally away from the transition region E by the header rollers 126 of the header assembly 114 in order to avoid the elevator assembly 120. Incidentally, the momentum imparted to these crops causes them to continue moving laterally when they reach the conveyor 122, in opposition to the rearward movement of the conveyor 122. Hence, it will be appreciated that the need to avoid transition region E can lead to the formation of a second stagnation area generally designated at region F in which the crops must “turn the corner” and change from lateral to rearward motion.

Stagnation is especially common where the stationary structure is in the middle of the flowpath and the crops must separate and move around it. For example, FIG. 3 shows another common harvester flowpath configuration, wherein a header roller assembly 210 is separated from a grabroller assembly 212 by a wall or stationary mounting structure 214. In order for the crops to flow from the lifting assembly 216 to the elevator assembly 218, they must be moved laterally away from the wall 214 by the header rollers 220 of the header assembly 210, then they must be re-centered by the grabrollers 222 of the grabroller assembly 212 so that they can be passed to the elevator assembly 218. The transition region G directly behind the wall 214 is a common stagnation point for reasons similar to region A of FIG. 1, because the grabrollers 222 must move the crops both centrally and downstream. It will also be seen that the consecutive spreading and funneling action of the header rollers 220 and the grabrollers 222 requires the crops to “turn the corner,” which tends to create a stagnation area generally designated at regions H.

As will be appreciated by those of ordinary skill in the art, different harvesters have different stagnation problems and at varying locations, so the above examples are merely exemplary.

Accordingly, a general aspect or object of the present invention is to provide improved flow through root crop harvesters.

Another aspect or object of the present invention is to improve root crop harvesters by positioning a stagnation reduction assembly or member at one or more locations along the harvested crop flowpath of the implement, the stagnation reduction device imparting movement action to the harvested crops passing thereby.

Other aspects, objects and advantages of the present invention, including the various features used in various combinations, will be understood from the following description according to preferred embodiments of the present invention, taken in conjunction with the drawings in which certain specific features are shown.

### SUMMARY OF THE INVENTION

In accordance with the present invention, root crop harvester flow systems provide improved flow and reduced stagnation. According to one aspect of the present invention, a root crop harvester flow system includes a frame assembly which is transportable over the ground. A header assembly, a lifting assembly, and a transfer assembly are affixed to the frame assembly. The header assembly is affixed to a front portion of the frame assembly, while the lifting assembly is affixed to the header assembly. The lifting assembly penetrates the ground to harvest root crops, which flow downstream to the transfer assembly. The transfer assembly includes a transfer surface for moving root crops downstream of the transfer surface. Typically, the transfer surface is a conveyor or a plurality of rollers, but it can also be a star-wheel cleaning bed or a potato chain cleaning bed or an elevator chain. A movable stagnation reduction member is associated with the transfer assembly and mounted for rotation such that the movable member engages root crops at a location generally above the transfer surface.

According to another aspect of the present invention, a root crop harvester flow system includes a frame assembly which is transportable over the ground. A header assembly is affixed to a front portion of the frame assembly, while a lifting assembly is affixed to the header assembly for penetrating the ground to harvest root crops. The harvested root crops flow downstream to a roller assembly, an elevator assembly, and a conveyor assembly A transition area is associated with at least one of the roller assembly, the elevator assembly, and the conveyor assembly. A movable stagnation reduction member is mounted at the transition area for rotation such that the movable member engages root crops at a location generally above the associated roller assembly, elevator assembly, or conveyor assembly.

In yet another aspect of the present invention, a root crop harvester has a frame assembly transportable over the ground and a header assembly affixed to a front portion of the frame assembly A lifting assembly is affixed to the header assembly and a roller assembly is affixed to the frame assembly for receiving root crops downstream of the lifting assembly. An elevator assembly and a conveyor assembly are also affixed to the frame assembly for receiving root crops downstream of the lifting assembly. The present invention improves upon such a harvester by providing a movable stagnation reduction member associated with at least one of the roller assembly, the elevator assembly, and the conveyor assembly. The movable member is mounted for rotation such that it engages root crops at a location generally above the associated roller assembly, elevator assembly, or conveyor assembly.

### BRIEF DESCRIPTION OF THE DRAWINGS

FIG. 1 is a schematic top plan view of the general flowpath of root crops through a prior art harvester;

FIG. 2 is a schematic top plan view of the general flowpath of root crops through another prior art harvester;

FIG. 3 is a schematic top plan view of the general flowpath of root crops through yet another prior art harvester;

FIG. 4 is a top plan view of a root crop harvester, generally corresponding to the harvester of FIG. 1, with a flow assist system according to an aspect of the present invention;

FIG. 5 is a schematic side elevational view of the flow of crops through the harvester shown in FIG. 4, illustrating multiple stagnation reduction devices;

FIG. 6 is a detail perspective view of a portion of the header assembly of FIG. 4;

FIG. 7 is a left side elevational view of the assembly of FIG. 6;

FIG. 8 is a schematic top plan view of another root crop harvester, generally corresponding to the harvester of FIG. 2, with a flow assist system according to an aspect of the present invention;

FIG. 9 is a schematic top plan view of yet another root crop harvester, generally corresponding to the harvester of FIG. 3, with a flow assist system according to an aspect of the present invention; and

FIG. 10 is a detail perspective view of a portion of the conveyor assembly of FIG. 8.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

Equipment and methods of the types described herein are for harvesting crops that grow within the ground, at times referred to as root crops. From time to time herein, these are referred to by terms such as “beets,” “sugarbeets,” “row crops,” and “root crops.” These terms are used substantially interchangeably, insofar as the invention has generally equal applicability to any such crops.

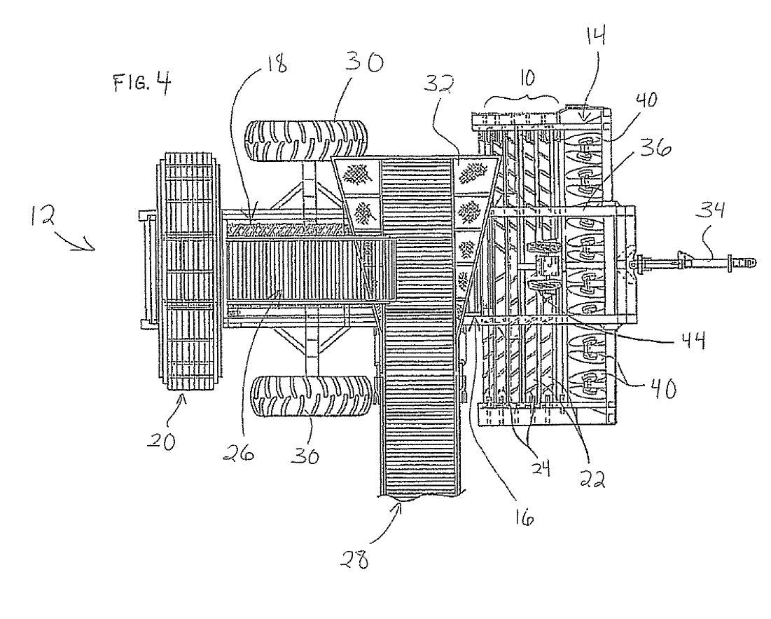

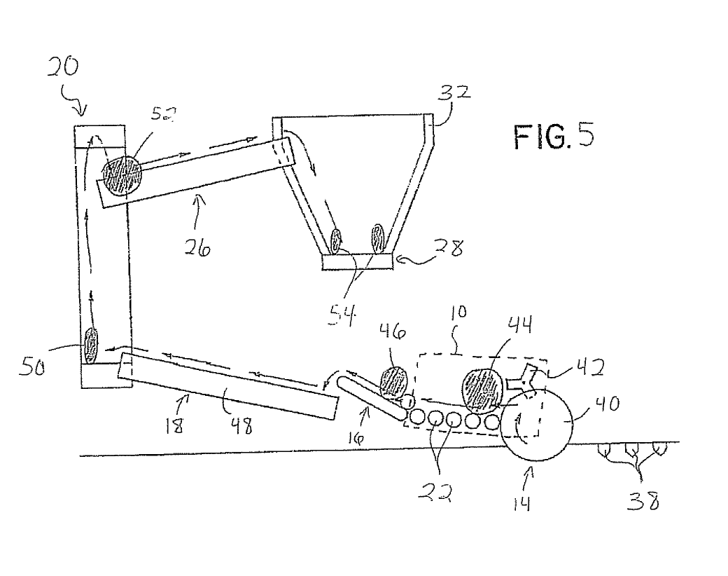

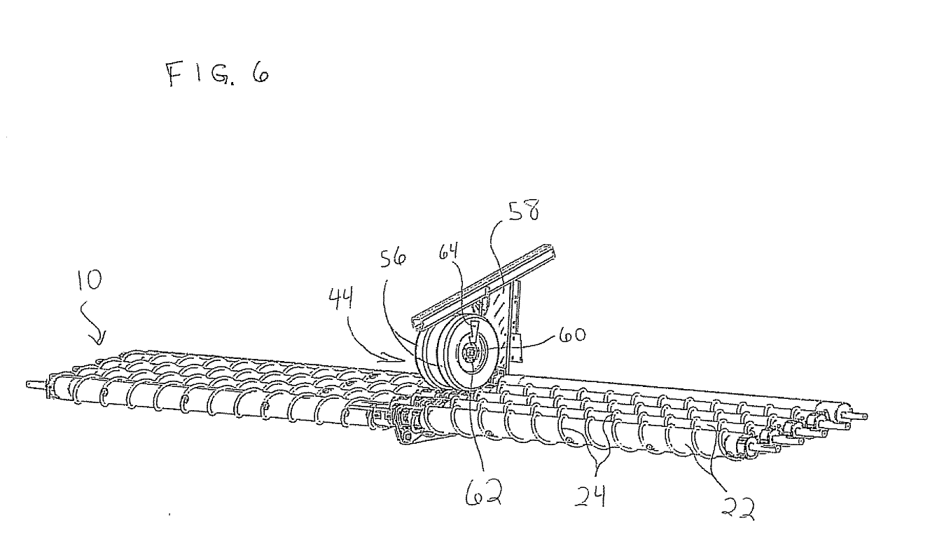

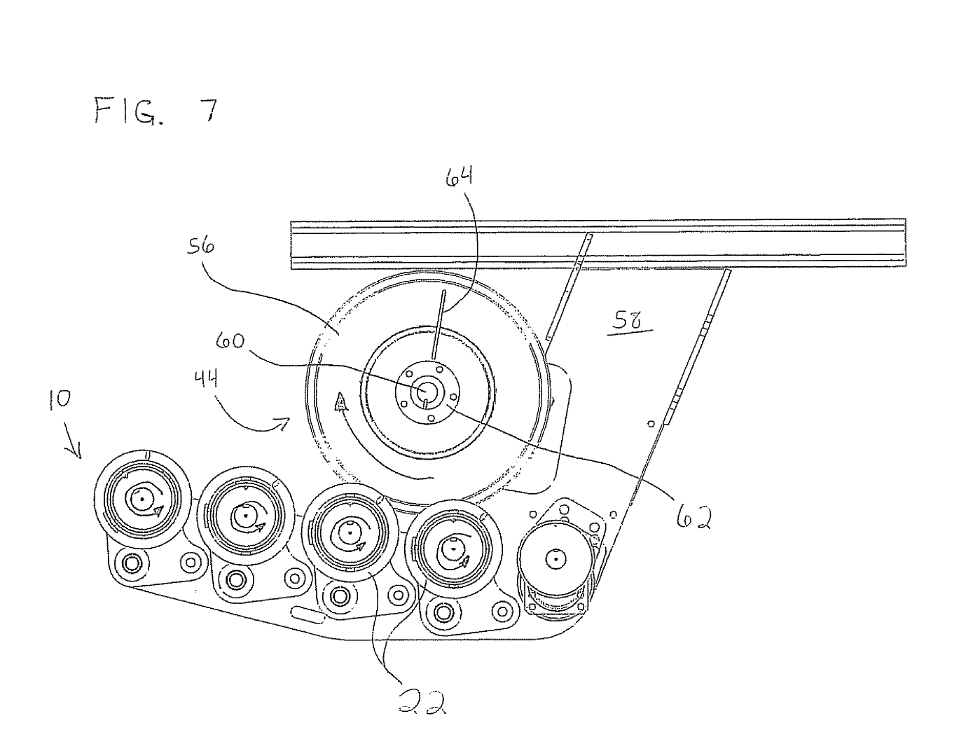

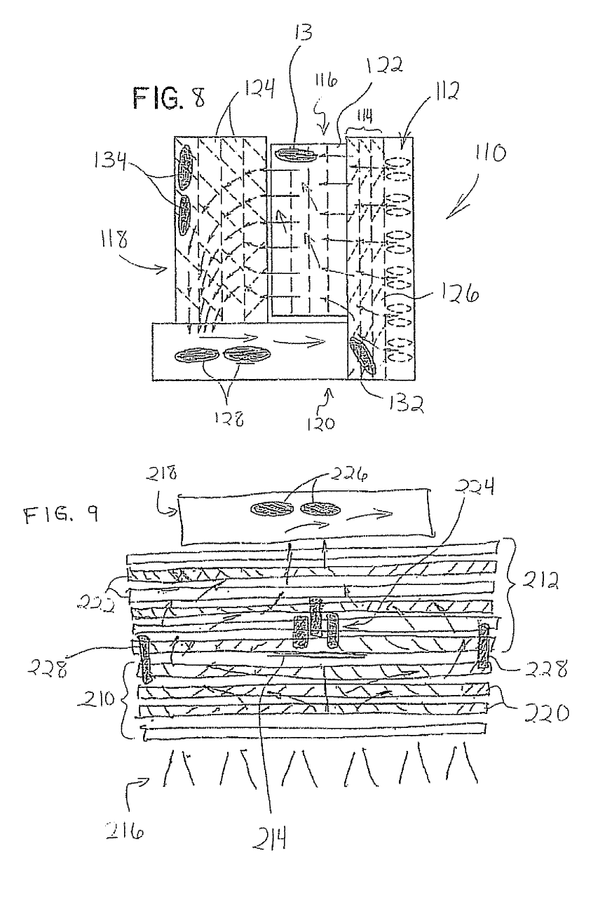

The general structure and operation of the preferred embodiment that is illustrated in FIG. 4 may be understood with reference to the above description of FIG. 1. Structures common to both FIGS. 1 and 4 are identified with the same reference numerals. A more detailed discussion of the general structure and operation of a harvester according to FIG. 4 is included in U.S. Patent Application Publication No 2005/0257939, which is hereby incorporated herein by reference. The beet harvester 12 includes a header assembly, generally designated at 10, a short conveyor assembly, generally designated at 16, a grabroller assembly, generally designated at 18, an elevator assembly, generally designated at 20, a tank conveyor assembly generally designated at 26, and an offloading conveyor assembly, generally designated at 28. These components are transfer assemblies that define a portion of a flowpath through the harvester 12 and move beets downstream. It will be appreciated that a harvester may include different transfer assemblies without departing from the scope of the present invention. Carrier wheels 30 and a holding tank 32 also are provided. A tongue assembly, generally designated at 34, and a lifting assembly 14 are positioned at a front portion of the header assembly 10. All of the preceding components are affixed to a frame assembly 36 that is transportable over the ground when pulled by a tractor or other transport vehicle, which is not illustrated.

The flowpath of beets through the harvester 12 is generally illustrated in FIG. 5. The beets 38 are unearthed by lifter wheels 40 of the lifting assembly 14 and then are contacted and moved downstream by rotating paddles 42. The header assembly 10 includes a plurality of header rollers 22 as a transfer surface that passes the beets downstream and funnels them into the relatively narrow short conveyor assembly 16. The stagnation problem associated with this funneling action is substantially eliminated by a movable stagnation reduction member 44 associated with the header assembly 10. The structure and operation of the multiple movable members that are illustrated in FIG. 5 will be described in greater detail herein.

After the beets have been funneled into the short conveyor assembly 16, which may include another movable member 46, they are moved downstream to the grabroller assembly 18. The beets travel the length of the grabrollers 48, which drop the beets into the elevator assembly 20 at the rear of the harvester 12. The elevator assembly 20 may also include a movable stagnation reduction member 50 associated with an inlet portion. The elevator assembly 20 lifts the beets and drops them onto the tank conveyor assembly 26, which may include a movable member 52 at a receiving portion generally adjacent to the elevator assembly 20. The tank conveyor assembly 26 drops the crops into a holding tank 32. The beets are finally removed from the harvester 12 by the offloading conveyor assembly 28 to a waiting truck or other appropriate vehicle. In order to prevent or minimize any stagnation and to assist the flow of beets up a steep incline, the offloading conveyor assembly 28 may be provided with at least one movable member 54.

The movable stagnation reduction member 44 is best illustrated in FIGS. 6 and 7. The general operation and structure of the other movable members of FIG. 5 are in accordance with the following description, unless noted otherwise. In the illustrated embodiment, the movable member 44 comprises a pair of disks 56 that are each mounted on opposite sides of a central support 58 of the header assembly by an axle 60 and a bearing 62. Unless stated otherwise, it is understood that a mounting assembly similar to the one illustrated in FIGS. 6 and 7 is suitable for use with any movable member and transfer assembly described herein. Those having ordinary skill in the art will also recognize that other mounting assemblies are possible and may be practiced without departing from the scope of the present invention.

The disks 56 are generally adjacent to the header rollers 22, such that beets moved toward the center of the header rollers will contact the disks 56, which generally occupy the transition area A illustrated in FIG. 1. In a preferred embodiment, the disks 56 are in rolling or frictional contact with the header rollers 22, which causes the disks 56 to rotate in the opposite direction of the header rollers 22, as shown in FIG. 7. These need not be driven. Alternatively, the disks 56 may be driven typically by a mechanical or hydraulic system that is separate from or coupled to the header roller drive system. Of course, if the movable member 44 is driven or powered, then it may be placed in rolling contact with a transfer surface to drive that surface or to at least assist in driving that surface.

The disks 56 may be provided with one or more paddles or striking members 64 to strike the beets and force them downstream. Even without the striking members 64, the disks 56 effectively create a “moving wall” that prevents or reduces stagnation by occupying the transition area A and providing a movable surface to address stagnation, such as by urging the beets downstream.

If the movable stagnation reduction members such as the disks 56 can be mounted for rotation about an axis substantially parallel to a rotational axis of the transfer surface, as is the case with all of the movable members of FIG. 5, then the present invention may be very easily implemented. For example, it has been found that a pair of automobile spare tires provides suitable disks for use in the header assembly of a twelve-row, 22-inch row Art's Way model 6812 beet harvester. Of course, the size and composition of a movable member depends on several factors, such as the nature of the associated transfer surface, the location of suitable mounting structures, field and crop conditions, etc. It is contemplated that the movable members are removably mounted, such that they may be removed to service the harvester or to simplify replacement or to allow interchangeability.

As for the other movable stagnation reduction members of FIG. 5, the short conveyor assembly 16 preferably includes a movable member 46 generally disposed at each transition area C of FIG. 1. The short conveyor assembly 16 is narrower than the header assembly 10, so a bottleneck effect may be substantially prevented by the use of movable members 46. The stagnation region B associated with the inlet of the elevator assembly 20 is preferably occupied by a plurality of movable members 50. A comparable configuration may be seen in FIG. 9, which shows two movable members 226 in the flowpath through an elevator assembly 218. In addition to enhancing flow and preventing or reducing stagnation at the inlet of the elevator assembly 20, the movable members 50 may be driven and placed in rolling contact with the elevator assembly 20 to help power it.

The tank conveyor assembly 26 preferably includes at least one movable member 52, because the crops are forced to change transfer assemblies and to change direction after falling from the elevator assembly 20. The tank conveyor assembly 26 may be provided with a plurality of movable members, not illustrated, disposed at opposite lateral sides of the tank conveyor assembly 26 and/or a plurality of movable members at different downstream points along the tank conveyor assembly 26.

The movable members 54 associated with the offloading conveyor assembly 28 serve a similar purpose to the movable member(s) 52 associated with the tank conveyor assembly 26 and can also help convey crops if the offloading conveyor assembly 28 is relatively steep. It will be appreciated that movable stagnation reduction members having substantially horizontal rotational axes may be preferred for transfer surfaces having an upward incline, because such movable members tend to impart downstream and upward motion to the sugar beets.

In other applications where the transfer surface does not have an upward incline, the generally upward lift provided by the stagnation reduction device can provide improved stagnation reduction action. This can be illustrated in the embodiment of FIGS. 6 and 7. The curved arrow line in FIG. 7 illustrates lifting action that is important to root crops that engage and are moved by the disks 56. This lifting action is imparted even more forcefully and directly by the striking member 64, when provided. However lifting action is imparted, when same is imparted to row crops it adds a direction of movement to combat stagnation.

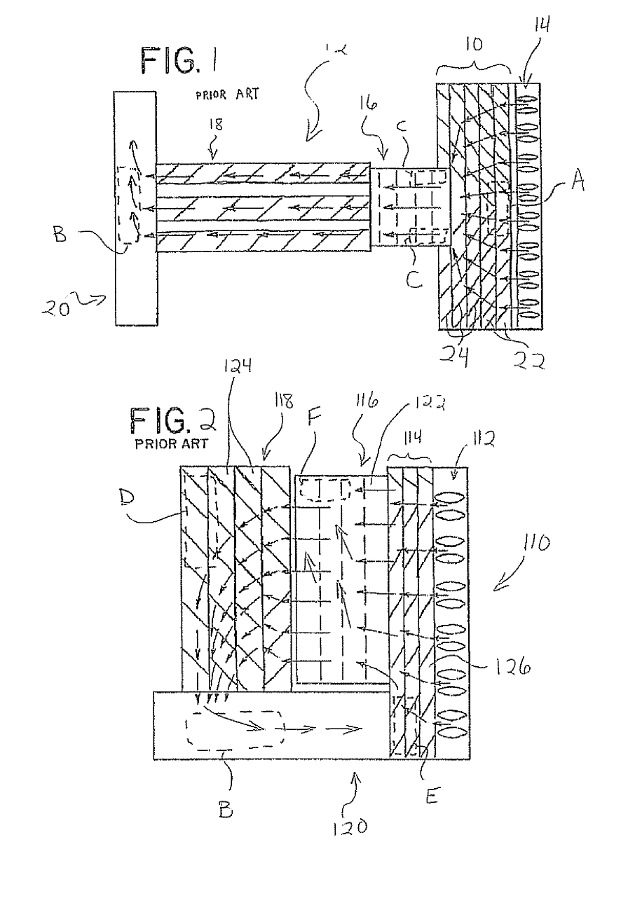

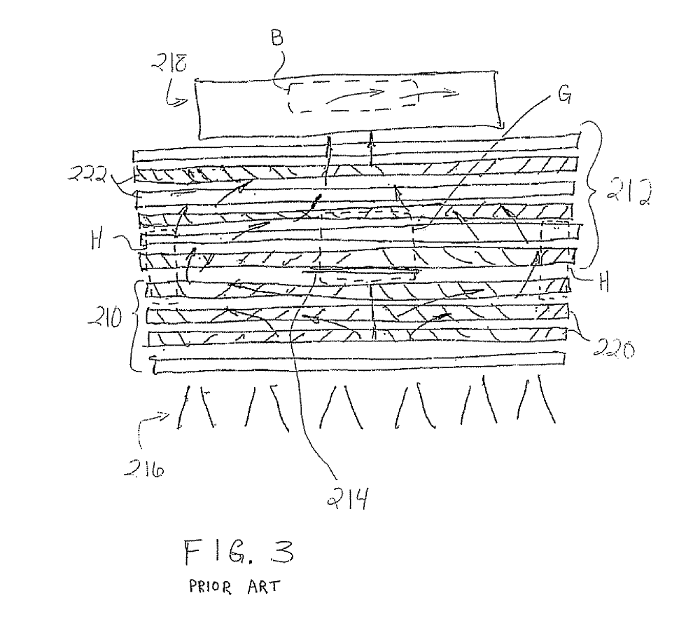

FIG. 8 illustrates various movable stagnation reduction members associated with the transition regions of a harvester 110 according to FIG. 2. Structures common to both FIGS. 2 and 8 are identified with the same reference numerals. The movable members 128 and 130 at regions B and F, respectively, each rotate about an axis substantially parallel to a rotational axis of the associated transfer surface, so they can be easily understood with reference to the preceding discussion of FIGS. 4-7.

However, movable stagnation reduction members according to the present invention may instead be orientated to rotate about an axis that is not parallel to a rotational axis of the associated transfer surface. For example, FIG. 8 illustrates movable members 132 and 134 associated with the header assembly 114 and with the grabroller assembly 118, respectively. The grabroller assembly 118 is illustrated with two associated movable members 134, but it will be appreciated that a single movable member or more than two movable members may be provided, depending on the needs of the particular harvester. This is also true for the other movable members described and illustrated herein, in that one having ordinary skill in the art can determine the proper number of movable members to include in a given stagnation region.

The movable member 132 associated with the header assembly 114 rotates about an axis at an acute angle to the rotational axes of the header rollers 126, while the movable members 134 associated with the grabroller assembly 118 rotate about axes substantially perpendicular to the rotational axes of the grabrollers 124. Thus, it will be appreciated that such movable members 132 and 134 are preferably at least slightly spaced above the associated transfer surface, because they may not be rotated by rolling contact with the associated transfer surface. On the contrary, such movable members 132 and 134 typically must be driven by a unit, such as a mechanical or hydraulic system, that is separate from or coupled to the drive system of the associated transfer surface. The design and selection of suitable drive systems are within the ability of one having ordinary skill in the art.

Alternatively, movable members that can function as stagnation reduction devices according to the present invention may be mounted to be slightly above the associated transfer surface, rather than being in contact with the same, and be provided without a driving mechanism. Such a free-rotation mounting configuration typically is best suited for a movable member that rotates about an axis that is at an angle with respect to a rotational axis of the associated transfer surface, such as the movable member 132 associated with the header rollers 126 of FIG. 8. For the illustrated movable member 132, it will be seen that the generally right-to-left flow of crops will contact the movable member 132 and cause it to rotate so as to urge the crops further downstream. It has been found that even a slight rotation improves flow through the harvester, so non-powered movable members may be preferred for their effectiveness and ease of implementation.

FIG. 9 illustrates various movable members associated with the transition regions of a harvester according to FIG. 3. Structures common to both FIGS. 3 and 9 are identified with the same reference numerals. All of the illustrated movable stagnation reduction members 224, 226, and 228 rotate about axes substantially parallel to a rotational axis of the associated transfer surface, so their general operation may be understood with reference to the above description of the movable members of FIGS. 4-7. The illustrated movable members 224 associated with the stagnation region G behind the wall 214 are arranged in a shingled pattern that may be useful over a longer distance or to optimize capacity and flow. Those of ordinary skill in the art will appreciate that a variety of other configurations are possible and within the scope of the present invention.

While the movable members illustrated in FIGS. 4-9 are associated with stagnation regions and/or transition areas, it is believed that the use of movable members can improve flow at virtually any portion of the flowpath through the harvester. For example, transfer assemblies are typically provided with guardrails to prevent crops from falling out of the harvester. These guardrails are stationary walls and may slow the flow of crops that come into contact therewith. It will be appreciated that the provision of “moving walls” to overlay these existing stationary walls will assist the downstream flow of crops through a harvester by eliminating potential stationary contact points.

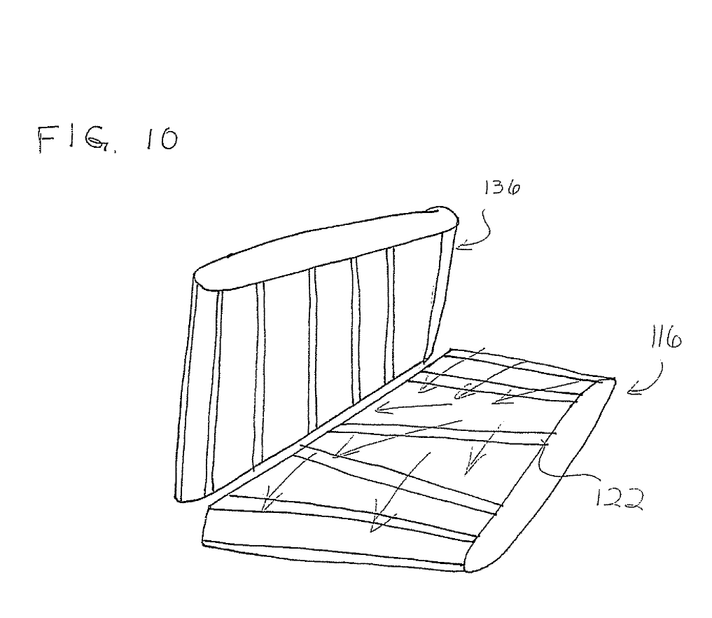

While other stagnation reduction devices shown herein provide movable wall action, FIG. 10 illustrates a particular unit that has a more wall-like appearance. FIG. 10 illustrates the conveyor assembly 122 of FIG. 8 with a movable stagnation reduction member 136 embodied as a modified draper chain that may substantially replace a guardrail typically disposed along a side of the conveyor assembly 122. Any of the movable stagnation reduction members or devices according to the present invention may be provided as a movable draper chain or according to similar conveyor configurations. Draper chain assemblies are of a structure generally known in the art. Such configurations are generally preferred for use along the outer edges of the flowpath.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

1. A root crop harvester flow system comprising:
a frame assembly transportable over the ground;
a header assembly affixed to a front portion of said frame assembly;
a lifting assembly for penetrating the ground and lifting root crops out of the ground, wherein said lifting assembly is affixed to said header assembly;
a transfer assembly affixed to said frame assembly for receiving root crops downstream of said lifting assembly;
a transfer surface associated with said transfer assembly for moving root crops downstream of said transfer assembly; and
a movable stagnation reduction member associated with said transfer assembly and mounted for rotation such that same engages root crops at a location generally above said transfer surface.

2. The root crop harvester flow system of claim 1, wherein the movable stagnation reduction member includes a disk rotatable about an axis substantially parallel to a rotational axis of said transfer surface.

3. The root crop harvester flow system of claim 2, wherein said disk is in rotational contact with said transfer surface.

4. The root crop harvester flow system of claim 2, wherein said movable stagnation reduction member further comprises a plurality of rotatable disks.

5. The root crop harvester flow system of claim 4, wherein at least two of said rotatable disks have rotational axes different from each other.

6. The root crop harvester flow system of claim 1, wherein the movable stagnation reduction member is rotatable about an axis oriented at an angle with respect to a rotational axis of said transfer surface, such that the movable stagnation reduction member axis and the rotational axis of the transfer surface are non-parallel to each other.

7. The root crop harvester flow system of claim 1, wherein the movable stagnation reduction member includes a striking member mounted for contact with harvested root crops during operation thereof.

8. The root crop harvester flow system of claim 1, wherein said movable stagnation reduction member further comprises a movable draper chain.

9. The root crop harvester flow system of claim 1, wherein said transfer surface is substantially comprised of a plurality of rollers.

10. The root crop harvester flow system of claim 1, wherein said transfer surface is substantially comprised of a conveyor.

11. A root crop harvester flow system comprising:
a frame assembly transportable over the ground;
a header assembly affixed to a front portion of said frame assembly;
a lifting assembly for penetrating the ground and lifting root crops out of the ground, wherein said lifting assembly is affixed to said header assembly;
a roller assembly affixed to said frame assembly for receiving root crops downstream of said lifting assembly;
an elevator assembly affixed to said frame assembly for receiving root crops downstream of said lifting assembly;
a conveyor assembly affixed to said frame assembly for receiving root crops downstream of said lifting assembly;
a transition area associated with one of said roller assembly, said elevator assembly, and said conveyor assembly; and
a movable stagnation reduction member mounted at said transition area for rotation such that same engages root crops at a location generally above at least one of said roller assembly, said elevator assembly, and said conveyor assembly.

12. The root crop harvester flow system of claim 11, wherein the movable stagnation reduction member includes a disk rotatable about an axis substantially parallel to a rotational axis of at least one of said roller assembly, said elevator assembly, and said conveyor assembly.

13. The root crop harvester flow system of claim 12, wherein said disk is in rotational contact with at least one of said roller assembly, said elevator assembly, and said conveyor assembly.

14. The root crop harvester flow system of claim 12, wherein said movable stagnation reduction member further comprises a plurality of rotatable disks.

15. The root crop harvester flow system of claim 14, wherein at least two of said rotatable disks have rotational axes different from each other.

16. The root crop harvester flow system of claim 11, wherein the movable stagnation reduction member is rotatable about an axis oriented to be non-parallel to a rotational axis of at least one of said roller assembly, said elevator assembly, and said conveyor assembly.

17. The root crop harvester flow system of claim 11, wherein the movable stagnation reduction member includes a striking member mounted for contact with harvested root crops during operation thereof.

18. A root crop harvester having a frame assembly transportable over the ground, a header assembly affixed to a front portion of said frame assembly, a lifting assembly affixed to said header assembly, a roller assembly affixed to said frame assembly for receiving root crops downstream of said lifting assembly, an elevator assembly affixed to said frame assembly for receiving root crops downstream of said lifting assembly, and a conveyor assembly affixed to said frame assembly for receiving root crops downstream of said lifting assembly, the improvement comprising:
a movable stagnation reduction member associated with at least one of said roller assembly, said elevator assembly, and said conveyor assembly and mounted for rotation such that said movable stagnation reduction member engages root crops at a location generally above same.

19. The root crop harvester flow system of claim 18, wherein the movable stagnation reduction member includes a disk rotatable about an axis substantially parallel to a rotational axis of at least one of said roller assembly, said elevator assembly, and said conveyor assembly.

20. The root crop harvester flow system of claim 19, wherein said disk is in rolling contact with at least one of said roller assembly, said elevator assembly, and said conveyor assembly.

21. The root crop harvester flow system of claim 19, wherein said movable stagnation reduction member further comprises a plurality of rotatable disks.

22. The root crop harvester flow system of claim 21, wherein at least two of said rotatable disks have rotational axes different from each other.

23. The root crop harvester flow system of claim 18, wherein the movable stagnation reduction member is rotatable about an axis oriented to be non-parallel to a rotational axis of at least one of said roller assembly, said elevator assembly, and said conveyor assembly.

24. The root crop harvester flow system of claim 18, wherein the movable stagnation reduction member includes a striking member mounted for contact with harvested root crops during operation thereof.
